(19) United States
(12) Patent Application Publication
(10) Pub. No.: US 2012/0173314 A1
(43) Pub. Date: Jul. 5, 2012

(54) SYSTEM AND METHOD FOR ACCUMULATING BONUS POINTS FROM PURCHASING GOODS USING IMAGE RECOGNITION CODE

(76) Inventor: Kang-il Lee, Hwasung-si (KR)

(21) Appl. No.: 13/338,849

(22) Filed: Dec. 28, 2011

(30) Foreign Application Priority Data
Jan. 3, 2011 (KR) 10-2011-0000032

(51) Int. Cl. G06Q 30/02

(52) U.S. Cl. 705/14.3

(57) ABSTRACT

A system and method for accumulating bonus points using an image recognition code are disclosed. The system for accumulating bonus points includes a customer terminal that analyzes a photographed image recognition code for point accumulation, transmits shop information and point accumulation request information in the analyzed image recognition code for point accumulation together with customer information, analyzes a photographed image recognition code for point deduction and transmits shop information and point deduction request information in the analyzed image recognition code for point deduction together with customer information, and a server that stores bonus point information by each shop for multiple customers, accumulates bonus points based on a customer's purchase of goods in the shop using the customer information, the shop information and the point accumulation request information transmitted from the customer terminal, and deducts accumulated bonus points based on the customer's purchase of goods in the shop using the customer information, the shop information. and the point deduction request information transmitted from the customer terminal.

### CROSS-REFERENCE TO RELATED APPLICATION

This application claims priority to and the benefit of Korean Patent Application No. 10-2011-0000032, filed on Jan. 3, 2011, the entire disclosure of which is incorporated herein by reference.

### BACKGROUND OF THE INVENTION

1. Field of the Invention

The present invention relates to a system and method for accumulating bonus points using an image recognition code, and more particularly, to technology of accumulating bonus points of customers buying goods by recognizing an image code for use in accumulation issued to a shop and deducting accumulated bonus points by recognizing an image code for use in point deduction issued to the shop.

2. Description of the Related Art

In general, in order to increase customers' return visits, shops use the following marketing methods.

One of the marketing methods is to issue a reward card for point accumulation in paper form. A shop accumulates bonus points on the basis of a purchase by stamping a paper card or putting a sticker on the paper card. However, this method may cause inconvenience to customers because they have to carry paper cards for multiple shops and there is a high risk of losing the cards. In addition, whenever points need to be accumulated at a shop, a customer should look for a paper card for point accumulation provided from the shop, which is quite cumbersome. Meanwhile, it is not possible for the shop to identify current points accumulated for the customer on a real time basis.

Another method of the marketing methods is to issue a point or mileage card. That is to say, shops issue magnetic cards to customers. According to this method, however, inconvenience is caused to the customers because they have to carry the magnetic cards. In addition, separate hardware devices for accumulating bonus points on the magnetic cards should be provided in the shops, which may incur an increased cost in the customers receiving the magnetic cards.

Still another method of the marketing methods is to accumulate bonus points based on customer's personal information. Since this method is based on customers' personal information, customers need not to carry separate magnetic cards or paper cards for point accumulation. However, there is a risk of inadvertently disclosing the personal information from shops.

### BRIEF SUMMARY OF THE INVENTION

Aspects of the present invention provide a system and method for accumulating bonus points using an image recognition code, which is configured to prevent customer's personal information from being disclosed at the time of accumulating the bonus points without having to inconveniently carry a paper or magnetic card for point accumulation based on a purchase.

In accordance with one aspect of the present invention, there is provided a system for accumulating bonus points using an image recognition code, the system including a customer terminal that analyzes a photographed image recognition code for point accumulation, transmits shop information and point accumulation request information in the analyzed image recognition code for point accumulation together with customer information, analyzes a photographed image recognition code for point deduction and transmits shop information and point deduction request information in the analyzed image recognition code for point deduction together with customer information, and a server that stores bonus point information by each shop for multiple customers, accumulates bonus points based on a customer's purchase of goods in the shop using the customer information, the shop information and the point accumulation request information transmitted from the customer terminal, and deducts accumulated bonus points based on the customer's purchase of goods in the shop using the customer information, the shop information and the point deduction request information transmitted from the customer terminal.

The server may further store use standard point information by each shop, may identify whether the customer's bonus points accumulated by each shop can be used or not using the use standard point information by each shop and may transmit the identification result to the customer terminal.

The server may store an image recognition code for point accumulation and an image recognition code for point deduction, which are characteristic by each shop.

The server may further store advertisement information by each shop.

The server may transmit advertisement information of a shop having the lowest or highest bonus points based on the customer's bonus point information by each shop to the customer terminal.

The server may additionally accumulate preset points to the points for the shop of the customer having received the advertisement information.

The image recognition code for point accumulation and the image recognition code for point deduction may be configured using quick response (QR) codes.

In accordance with another aspect of the present invention, there is provided a customer terminal including a communication unit that performs communication with a server managing accumulation and deduction of bonus points by each shop for multiple customers; a camera that photographs an image recognition code for point accumulation and an image recognition code for point deduction; an analysis unit that analyzes the photographed image recognition codes for point accumulation and deduction; an accumulation request unit that transmits to the server shop information and point accumulation request information in the analyzed image recognition code for point accumulation together with customer information from the customer terminal; and a deduction request unit that transmits to the server shop information and point deduction request information in the analyzed image recognition code for point deduction together with customer information from the customer terminal.

In accordance with still another aspect of the present invention, there is provided a server including a point database (DB) that stores point information by each shop for multiple customers; a point accumulation unit that accumulates customer's bonus points based on a purchase of goods from a shop in the point DB according to customer information, shop information and point accumulation request information transmitted from a customer terminal; and a point deduction unit that deducts customer's accumulated bonus points based on a purchase of goods from a shop in the point DB according to customer information, shop information and point deduction request information transmitted from the customer terminal.

The point DB may further store use standard point information by each shop.

The server may further include a usable point identification unit that identifies whether the customer's bonus points accumulated by each shop can be used or not using the use standard point information by each shop and transmits the identification result to the customer terminal.

The server may further include an image recognition code storage DB that stores an image recognition code for point accumulation and an image recognition code for point deduction, which are characteristic by each shop.

The server may further include an advertisement DB that stores advertisement information by each shop.

The server may further include an advertisement transmission unit that identifies advertisement information of a shop having the lowest or highest bonus points from the advertisement DB and transmits the identified advertisement information to the customer terminal.

The point accumulation unit may additionally accumulate preset points to the points for the shop of the customer having received the advertisement information.

In accordance with still another aspect of the present invention, there is provided a method for accumulating bonus points using an image recognition code, the method including allowing a customer terminal to analyze a photographed image recognition code for point accumulation, to transmit shop information and point accumulation request information in the analyzed image recognition code for point accumulation together with customer information, to analyze a photographed image recognition code for point deduction and to transmit shop information and point deduction request information in the analyzed image recognition code for point deduction together with customer information; and allowing a server to store bonus point information by shop for multiple customers, to accumulate bonus points based on a customer's purchase of goods in the shop using the customer information, the shop information and the point accumulation request information transmitted from the customer terminal, and to deduct accumulated bonus points based on the customer's purchase of goods in the shop using the customer information, the shop information and the point deduction request information transmitted from the customer terminal.

The method may further include allowing the server to identify whether the customer's bonus points accumulated by each shop can be used or not using the use standard point information by each shop and to transmit the identification result to the customer terminal.

The method may further include allowing the server to transmit advertisement information of a shop having the lowest or highest bonus points from pre-stored advertisement information by each shop to the customer terminal.

The transmitting of the advertisement information may include additionally accumulating preset points to the points for the shop of the customer having received the advertisement information.

The method may further include storing an image recognition code for point accumulation and an image recognition code for point deduction, which are characteristic by each shop.

As described above, in the system and method for accumulating bonus points using an image recognition code according to an embodiment of the present invention, bonus points are accumulated based on goods purchase by recognizing an image code for point accumulation issued to a shop and the accumulated bonus points are deducted.

Additional aspects and/or advantages of the invention will be set forth in part in the description which follows and, in part, will be obvious from the description, or may be learned by practice of the invention.

### BRIEF DESCRIPTION OF THE DRAWINGS

The objects, features and advantages of the present invention will be more apparent from the following detailed description in conjunction with the accompanying drawings, in which:

FIG. 1 illustrates a configuration of a system for accumulating bonus points using an image recognition code according to an embodiment of the present invention; FIG. 2 illustrates a configuration of a customer terminal according to an embodiment of the present invention;

FIG. 3 illustrates a configuration of a server according to an embodiment of the present invention; and

FIG. 4 is a flowchart of a method for accumulating bonus points using an image recognition code according to an embodiment of the present invention.

### DETAILED DESCRIPTION OF THE INVENTION

Hereinafter, embodiments of the present invention will he described in detail with reference to the accompanying drawings. If it is determined that a detailed description of well-known functions or constructions may obscure the invention, the well-known functions or constructions will not be described in detail to avoid obscuring the invention. In addition, the terms that follow are defined in consideration of functions in the present invention and may vary according to users, operator's intension or practice. Therefore, the terms should be defined based on the teachings of the present invention.

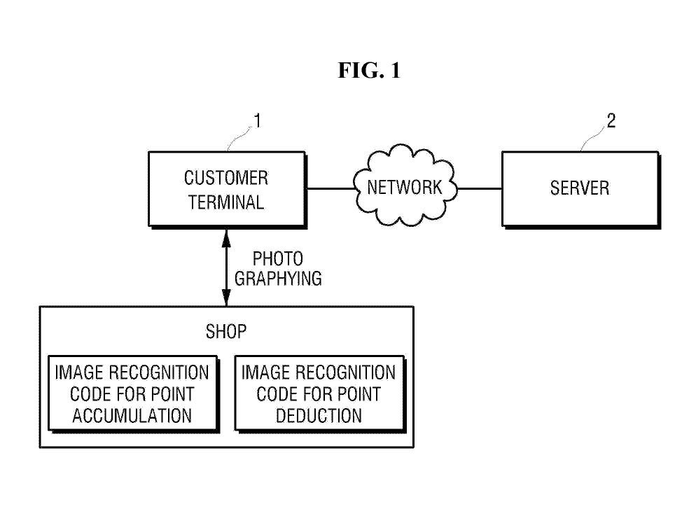

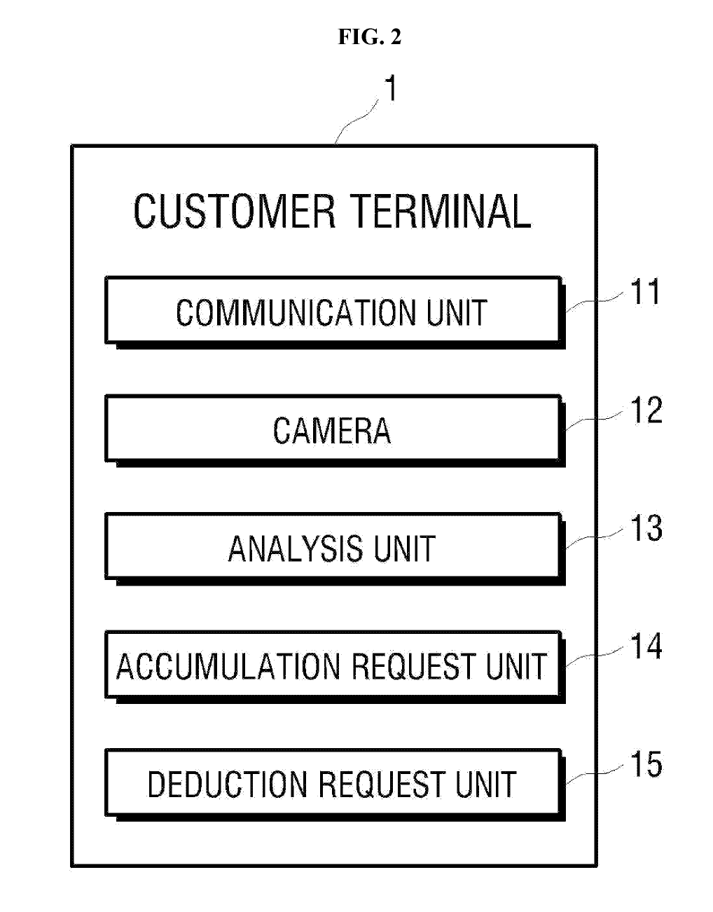

FIG. 1 illustrates a configuration of a system for accumulating bonus points using an image recognition code according to an embodiment of the present invention.

As shown in FIG. 1, the system for accumulating bonus points using an image recognition code according to an embodiment of the present invention includes a customer terminal 1 and a server 2. Here, the customer terminal 1 may he a mobile terminal such as a mobile phone, a smart phone or a tablet PC.

The customer terminal 1 analyzes a image recognition code for point accumulation, which is photographed based on a goods purchase at a shop by a clerk of the shop or a customer purchasing goods, and transmits shop information and point accumulation request information in the analyzed image recognition code together with customer information to the server 2. Here, the network may be a wired network or a wireless network. The wired network may be a wired internet and the wireless network may be a wireless internet.

The customer terminal 1 analyzes an image recognition code for point deduction, which is photographed for using bonus points accumulated at the shop based on goods purchase by a clerk of the shop or a customer purchasing goods, and transmits shop information and point deduction request information in the analyzed image recognition code together with customer information to the server 2. Here, the image recognition code for point accumulation and the image recognition code for point deduction may be configured using quick response (QR) codes.

The server 2 stores bonus point information by each shop for multiple customers, and accumulates bonus points based on a customer's purchase of goods in the shop using the customer information, the shop information and the point accumulation request information transmitted from the customer terminal 1. In addition, the server 2 deducts accumulated bonus points based on the customer's purchase of goods in the shop using the customer information, the shop information and the point deduction request information transmitted from the customer terminal 1.

The server 2 according to an embodiment of the present invention may further store use standard point information by each shop. Accordingly, the server 2 may identify whether the customer's bonus points accumulated by each shop can be used or not using the use standard point information by each shop and may transmit the identification result to the customer terminal 1. Thus, the customer may identify information transmitted to the customer terminal 1, which indicates whether the customer's bonus points accumulated by each shop can be used or not, and may determine whether to use the bonus points accumulated in the shop or not.

Further, the server 2 may further store an image recognition code for point accumulation and an image recognition code for point deduction, which are characteristic by each shop. The server 2 may confirm sales status of each shop using the image recognition code for point accumulation and the image recognition code for point deduction, which are characteristic by each shop.

Further, the server 2 may further store advertisement information by each shop. Accordingly, the server 2 may transmit advertisement information of a shop having the lowest or highest bonus points based on the customer's bonus point information by each shop to the customer terminal 1. Here, the server 2 may additionally accumulate preset points to the points for the shop of the customer having received the advertisement information. In such a way, customer's purchase desire for the shop which provides the customer with bonus points may be stimulated, thereby increasing the shop's profit. Therefore, the operator of the server 2 may charge the shop for advertising expenses and may make profits when the advertising expenses are paid.

FIG. 2 illustrates a configuration of a customer terminal according to an embodiment of the present invention.

As shown in FIG. 2, the customer terminal 1 according to an embodiment of the present invention may include a communication unit 11, a camera 12, an analysis unit 13, an accumulation request unit 14 and a deduction request unit 15. Here, the customer terminal 1 may be a mobile terminal such as a mobile phone, a smart phone or a tablet PC.

The communication unit 11 performs communication with a server managing accumulation and deduction of bonus points by each shop for multiple customers. Here, the communication unit 11 may be connected to a server through a wired network or a wireless network.

The camera 12 photographs an image recognition code for point accumulation and an image recognition code for point deduction.

The analysis unit 13 analyzes the photographed image recognition codes for point accumulation and deduction.

The accumulation request unit 14 transmits to the server shop information and point accumulation request information in the analyzed image recognition code for point accumulation together with customer information from the customer terminal through the communication unit 11 to request for point accumulation.

The deduction request unit 15 transmits to the server shop information and point accumulation request information in the analyzed image recognition code for point deduction together with customer information from the customer terminal through the communication unit 11 to request for bonus deduction.

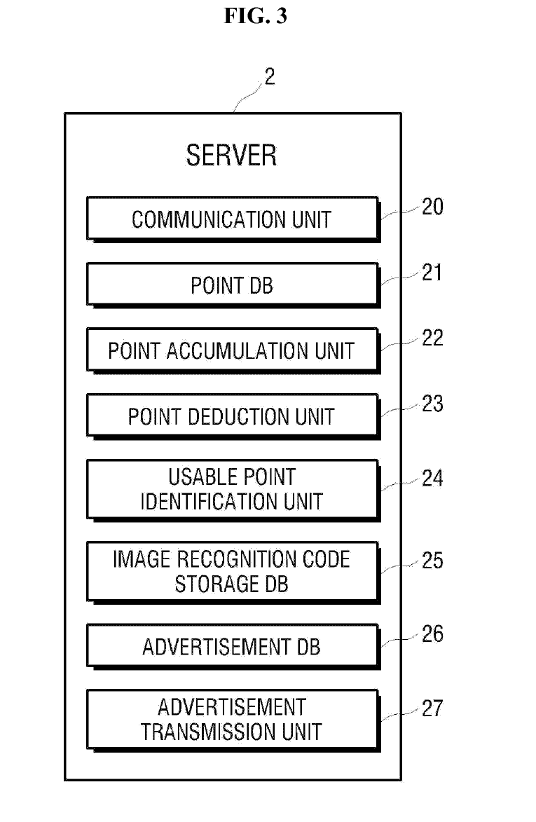

FIG. 3 illustrates a configuration of a server according to an embodiment of the present invention.

As shown in FIG. 3, the server 2 according to an embodiment of the present invention may include a point database (DB) 21, a point accumulation unit 22 and a point deduction unit 23. The server 2 may be connected to a network through the communication unit 11 and may transceiver data.

The point database (DB) 21 stores point information by each shop for multiple customers.

The point accumulation unit 22 accumulates customer's bonus points based on a purchase of goods from a shop in the point DB 21 according to customer information, shop information and point accumulation request information transmitted from a customer terminal.

The point deduction unit 23 deducts customer's accumulated bonus points based on a purchase of goods from a shop in the point DB 21 according to customer information, shop information and point deduction request information transmitted from the customer terminal.

Meanwhile, the point DB 21 may further store use standard point information by each shop.

The server 2 according to an embodiment of the present invention may further include a usable point identification unit 24 that identifies whether the customer's bonus points accumulated by each shop can be used or not using the use standard point information by each shop and transmits the identification result to the customer terminal.

The server 2 according to an embodiment of the present invention may further include an image recognition code storage DB 25 that stores an image recognition code for point accumulation and an image recognition code for point deduction, which are characteristic by each shop. Here, the image recognition code for point accumulation and the image recognition code for point deduction are configured using quick response (QR) codes.

In addition, the server 2 may further include an advertisement DB 26 that stores advertisement information by each shop. The server 2 may further include an advertisement transmission unit 27 that identifies advertisement information of a shop having the lowest or highest bonus points from the advertisement DB 26 and transmits the same to the customer terminal. Here, the point accumulation unit 22 may additionally accumulate preset points to the points for the shop of the customer having received the advertisement information.

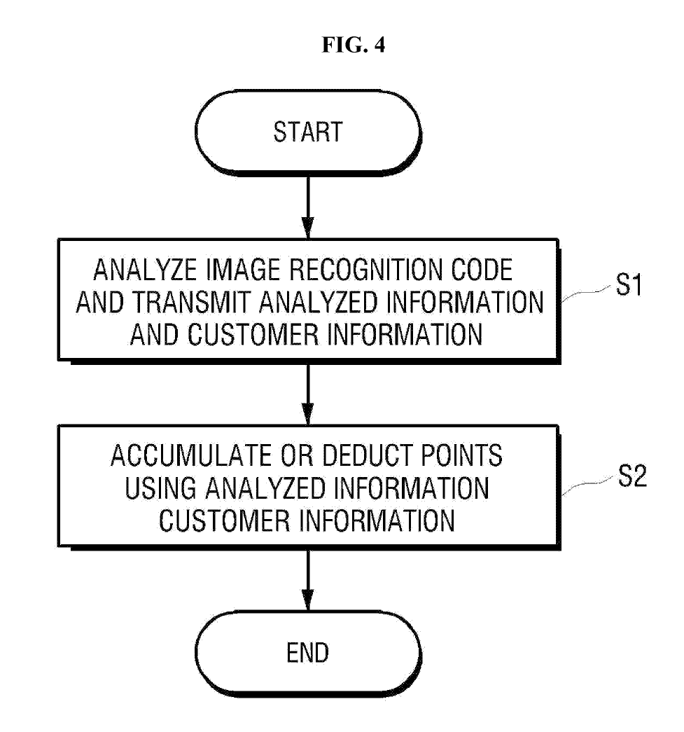

FIG. 4 is a flowchart of a method for accumulating bonus points using an image recognition code according to an embodiment of the present invention.

As shown in FIG. 4, the method for accumulating bonus points using an image recognition code according to an embodiment of the present invention may include allowing a customer terminal to analyze a photographed image recognition code for point accumulation or deduction, to transmit shop information and point accumulation request information in the analyzed image recognition code together with customer information, to analyze a photographed image recognition code for point deduction and to transmit shop information and point deduction request information in the analyzed image recognition code together with customer information (S1), and allowing a server to stores bonus point information by shop for multiple customers, to accumulate bonus points based on a customer's purchase of goods in the shop using the customer information, the shop information and the point accumulation request information transmitted from the customer terminal, and to deduct accumulated bonus points based on the customer's purchase of goods in the shop using the customer information, the shop information and the point deduction request information transmitted from the customer terminal (S2).

In addition, the method for accumulating bonus points using an image recognition code according to an embodiment of the present invention may further include allowing the server to identify whether the customer's bonus points accumulated by each shop can be used or not using the use standard point information by each shop and to transmit the identification result to the customer terminal.

In addition, the method for accumulating bonus points using an image recognition code according to an embodiment of the present invention may further include allowing the server to transmit advertisement information of a shop having the lowest or highest bonus points from pre-stored advertisement information by each shop to the customer terminal. Here, the server may additionally accumulate preset points to the points for the shop of the customer having received the advertisement information.

In addition, the method for accumulating bonus points using an image recognition code according to an embodiment of the present invention may further include storing an image recognition code for point accumulation and an image recognition code for point deduction, which are characteristic by each shop.

Although exemplary embodiments of the present invention have been described in detail hereinabove, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the claims appended hereto and the equivalents thereof.

1. A system for accumulating bonus points using an image recognition code, comprising:
a customer terminal that analyzes a photographed image recognition code for point accumulation, transmits shop information and point accumulation request information in the analyzed image recognition code for point accumulation together with customer information, analyzes a photographed image recognition code for point deduction and transmits shop information and point deduction request information in the analyzed image recognition code for point deduction together with customer information; and
a server that stores bonus point information by each shop for multiple customers, accumulates bonus points based on a customer's purchase of goods in the shop using the customer information, the shop information and the point accumulation request information transmitted from the customer terminal, and deducts accumulated bonus points based on the customer's purchase of goods in the shop using the customer information, the shop information and the point deduction request information transmitted from the customer terminal.

2. The system of claim 1, wherein the server further stores use standard point information by each shop, identifies whether the customer's bonus points accumulated by each shop can be used or not using the use standard point information by each shop and transmits the identification result to the customer terminal.

3. The system of claim 1, wherein the server stores an image recognition code for point accumulation and an image recognition code for point deduction, which are characteristic by each shop.

4. The system of claim 1, wherein the server further stores advertisement information by each shop.

5. The system of claim 4, wherein the server transmits advertisement information of a shop having the lowest or highest bonus points based on the customer's bonus point information by each shop to the customer terminal.

6. The system of claim 5, wherein the server additionally accumulates preset points to the points for the shop of the customer having received the advertisement information.

7. The system of one of claim 1, wherein the image recognition code for point accumulation and the image recognition code for point deduction are configured using quick response (QR) codes.

8. A customer terminal comprising:
a communication unit that performs communication with a server managing accumulation and deduction of bonus points by each shop for multiple customers;
a camera that photographs an image recognition code for point accumulation and an image recognition code for point deduction;
an analysis unit that analyzes the photographed image recognition codes for point accumulation and deduction;
an accumulation request unit that transmits to the server shop information and point accumulation request information in the analyzed image recognition code for point accumulation together with customer information from the customer terminal; and
a deduction request unit that transmits to the server shop information and point deduction request information in the analyzed image recognition code for point deduction together with customer information from the customer terminal.

9. The customer terminal of claim 8, wherein the image recognition code for point accumulation and the image recognition code for point deduction are configured using quick response (QR) codes.

10. A server comprising:
a point database (DB) that stores point information by each shop for multiple customers;
a point accumulation unit that accumulates customer's bonus points based on a purchase of goods from a shop in the point DB according to customer information, shop information and point accumulation request information transmitted from a customer terminal; and
a point deduction unit that deducts customer's accumulated bonus points based on a purchase of goods from a shop in the point DB according to customer information, shop information and point deduction request information transmitted from the customer terminal.

11. The server of claim 10, wherein the point DB further stores use standard point information by each shop.

12. The server of claim 11, further comprising a usable point identification unit that identities whether the customer's bonus points accumulated by each shop can be used or not using the use standard point information by each shop and transmits the identification result to the customer terminal.

13. The server of claim 10, further comprising an image recognition code storage DB that stores an image recognition code for point accumulation and an image recognition code for point deduction, which are characteristic by each shop.

14. The server of claim 10, wherein the image recognition code for point accumulation and the image recognition code for point deduction are configured using quick response (QR) codes.

15. The server of claim 10, further comprising an advertisement DB that stores advertisement information by each shop.

16. The server of claim 15, further comprising an advertisement transmission unit that identifies advertisement information of a shop having the lowest or highest bonus points from the advertisement DB and transmits the identified advertisement information to the customer terminal.

17. The server of claim 16, wherein the point accumulation unit additionally accumulates preset points to the points for the shop of the customer having received the advertisement information.

18. A method for accumulating bonus points using an image recognition code, the method comprising:
allowing a customer terminal to analyze a photographed image recognition code for point accumulation, to transmit shop information and point accumulation request information in the analyzed image recognition code for point accumulation together with customer information, to analyze a photographed image recognition code for point deduction and to transmit shop information and point deduction request information in the analyzed image recognition code for point deduction together with customer information; and
allowing a server to store bonus point information by shop for multiple customers, to accumulate bonus points based on a customer's purchase of goods in the shop using the customer information, the shop information and the point accumulation request information transmitted from the customer terminal, and to deduct accumulated bonus points based on the customer's purchase of goods in the shop using the customer information, the shop information and the point deduction request information transmitted from the customer terminal.

19. The method of claim 18, further comprising allowing the server to identify whether the customer's bonus points accumulated by each shop can be used or not using the use standard point information by each shop and to transmit the identification result to the customer terminal.

20. The method of claim 18, further comprising allowing the server to transmit advertisement information of a shop having the lowest or highest bonus points from pre-stored advertisement information by each shop to the customer terminal.

21. The method of claim 20, wherein the transmitting of the advertisement information comprises additionally accumulating preset points to the points for the shop of the customer having received the advertisement information.

22. The method of one of claim 18, further comprising storing an image recognition code for point accumulation and an image recognition code for point deduction, which are characteristic by each shop.

23. The method of claim 22, wherein the image recognition code for point accumulation and the image recognition code for point deduction are configured using quick response (QR) codes.
